(19) United States
(12) Patent Application Publication
(10) Pub. No.: US 2026/0124680 A1
(43) Pub. Date: May 7, 2026

(54) Method for Predictive Control of Laser Powder Bed Fusion

(71) Applicant: Northwestern University, Evanston, IL (US)

(72) Inventors: Dominik Kozjek, Domzale (SI); Jon-Erik Mogonye, Havre De Grace, MD (US); Conor Porter, Wilmette, IL (US); Jian Cao, Wilmette, IL (US); Fred M. Carter, III, Northfield, IL (US)

(73) Assignee: Northwestern University, Evanston, IL (US)

(21) Appl. No.: 19/379,126

(22) Filed: Nov. 4, 2025

Related U.S. Application Data
(60) Provisional application No. 63/715,910, filed on Nov. 4, 2024.

(51) Int. Cl. B22F 10/368; B22F 10/28; B22F 12/90; B33Y 10/00; B33Y 30/00; B33Y 50/02

(52) U.S. Cl. CPC B22F 10/368; B22F 10/28; B22F 12/90; B33Y 10/00; B33Y 30/00; B33Y 50/02

(57) ABSTRACT

A method for adaptive control of laser power during selective laser melting may include the steps of generating a toolpath for a part, calculating a mechanistic feature of the part, inputting a laser scanning speed and the calculated mechanistic feature of the part into a machine learning model, predicting meltpool temperature variations along the toolpath path based on the machine learning model, determining laser power adjustments based on predicted meltpool temperature variations. In some examples, the part may be generated from a metal, a ceramic, a polymer, or combinations thereof.

### CROSS REFERENCE TO RELATED APPLICATION(S)

This application is a continuation of and claims priority to U.S. Application No. 63/715,910 entitled Method for Predictive Control of Laser Powder Bed Fusion filed on Nov. 4, 2024, which is incorporated by reference in its entirety.

### STATEMENT OF GOVERNMENT INTERESTS

This invention was made with government support under grant numbers W911NF-21-2-0199 AND W911NF-20-2-0292 awarded by the U.S. Army Research Laboratory. The government has certain rights in the invention.

### FIELD OF THE INVENTION

The present disclosure relates to selective laser melting (SLM), a type of additive manufacturing process, and specifically to adaptive laser power control guided by machine learning to optimize the quality of manufactured parts.

### BACKGROUND

Selective Laser Melting (SLM), also known as Powder Bed Fusion (PBF), is a key technology in additive manufacturing, especially in industries that require highly precise and durable parts. Traditionally, SLM processes utilize static laser power settings, which fail to adapt to changing geometries and complex thermal behaviors during the manufacturing process. This can result in inconsistent quality, such as variations in porosity size, reduced material density, and defects in mechanical properties.

While closed-loop control (CLC) methods have been developed to address these issues, they primarily respond to observed defects and are limited by low temporal resolution. Existing methods lack the ability to dynamically and preemptively adjust laser power during the build process, especially on a sub-layer or intra-layer basis.

### SUMMARY

The system and methods disclosed herein are directed to an adaptive laser power control system for SLM that leverages real-time data from a co-axial photodiode monitoring system combined with a machine learning (ML) algorithm. The ML model, utilizing a random forest (RF) algorithm, predicts optimal laser power settings based on mechanistic features derived from the toolpath and geometry of a part to be manufactured. This adaptive control adjusts laser power dynamically during the build process, which results in improved material quality and reduced porosity.

In another example, the system and methods disclosed herein are directed to an additive manufacturing process including the steps of calculating a prescribed toolpath for at least one part, and generating the at least one part via the prescribed toolpath via a variable-power processing system and an in-situ sensor, in which the variable-power system dynamically adjusts power during a build process at specific points along the prescribed toolpath based on a predicted toolpath temperature.

### BRIEF DESCRIPTION OF THE DRAWINGS

FIG. 1 depicts a schematic overview of the adaptive laser power control system, showing the workflow and a completed build with the part of interest circled in red (MPM-meltpool monitoring; GAMMA-Generalized Analysis of Multiscale Multiphysics Applications, a thermal simulation code).

FIG. 2 graphically depicts the linear relationship between changes in laser power and changes in meltpool temperature, derived from thermal simulations.

FIG. 3 depicts laser power corrections applied to a single layer during the SLM process.

FIG. 4 shows XCT analysis of a baseline sample with external geometric accuracy displayed on the left and porosity shown as red dots on the right.

FIG. 5 depicts a baseline sample compared with an adaptive 0.5× sample.

FIG. 6 graphically depicts TEP distribution metric (TEP-DM) for baseline and controlled builds for the entire build height with moving average filter of 10 layers.

FIG. 7 graphically depicts TEP distribution metric (TEP-DM) for baseline and controlled builds for layers 55-85.

### DETAILED DESCRIPTION

Improved dynamic control of Selective Laser Melting (SLM), also referred to as Powder Bed Fusion (PBF), is crucial for its broader adoption in high-stakes industries. Currently, most commercially produced SLM parts are manufactured using static laser parameters that were developed on simple, constant cross-section witness coupons. However, these parameters, optimized for uniform geometries and toolpaths, do not effectively transfer to complex, real-world parts due to varying meltpool and thermal behavior influenced by intricate geometries and toolpaths. Addressing this discrepancy requires adaptive control mechanisms that can adjust laser parameters in real-time based on part geometry and toolpath variations during the build process.

Previous research into SLM control has primarily focused on closed-loop control (CLC) methods. Cai et al. [1] provided a comprehensive review of control methodologies in SLM, which can be broadly categorized into inter-layer and intra-layer control approaches. Inter-layer control strategies typically adjust laser power for subsequent layers based on the heat accumulated in prior layers. For instance, Rezaeifar et al. [2] employed coaxial pyrometry to measure average layer temperatures, demonstrating that adjusting laser power using CLC led to a more uniform microstructure in thin-wall geometries. Similarly, Riensche et al. [3] and Kavas et al. [4] utilized temperature monitoring techniques to adjust laser power between layers, achieving improved microstructural uniformity and better management of accumulated heat. However, these inter-layer approaches lack the fine resolution needed to control meltpool dynamics within a single layer.

In contrast, intra-layer control offers a higher resolution for meltpool management. Renken et al. [5] and Wang et al. [6] demonstrated CLC techniques that adjust laser power within a single layer, using real-time temperature feedback from coaxial photodiodes and pyrometry. However, their experimental setups involved scanning strategies (e.g., single tracks and simplified geometries) that did not fully represent the complexities of real-world parts, such as intricate scan regions and fast laser turnarounds. Furthermore, sensor response times and system speeds were insufficient to capture key meltpool behaviors at common scan speeds. Notably, all CLC methods remain reactive, meaning they correct process irregularities after they occur and often struggle with scaling to the high dimensionality of SLM variables.

Higher-resolution control has been demonstrated by Srinivasan et al. [7], who developed a method for adjusting laser parameters on a scan-vector basis, although it could not fully account for sub-vector level effects like turnaround heating. Liao et al. [8] applied combined feedforward-feedback control in Directed Energy Deposition (DED) to generate an initial laser power profile via simulation and then refined it through closed-loop adjustments based on coaxial pyrometry signals. This method effectively handled complex turnaround regions by providing an accurate initial laser power configuration.

While these prior efforts have improved part quality through control, current methods remain reactive, lack scalability, and fail to account for critical meltpool phenomena like temperature spikes at laser turnarounds in complex geometries. This work introduces a high-resolution intra-layer laser power control strategy, utilizing a pre-trained machine learning (ML) model and numerical simulation, validated through X-ray Computed Tomography (CT) analysis.

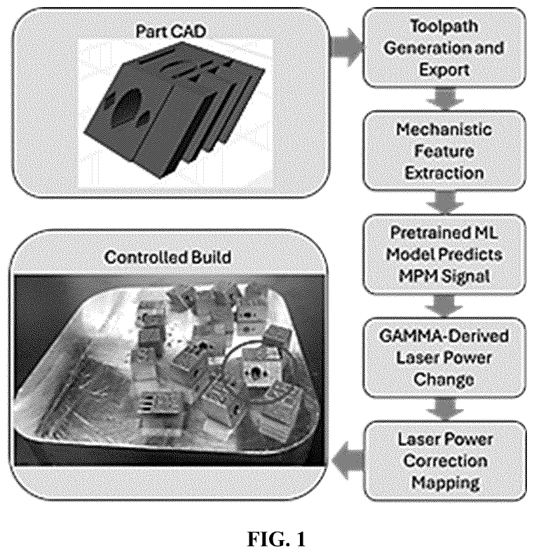

The system and process disclosed herein aims to dynamically adjust laser power along the scanning path, providing more localized control than methods that average laser power across layers or regions. This approach is also designed to be geometry-agnostic, making it applicable to various part geometries and builds. Changes in laser power are calculated relative to a nominal constant laser power used in baseline builds. Machine learning (ML) methodology was employed developed in prior work [9], which predicts meltpool monitoring (MPM) signals based on part geometry. These predictions drive dynamic adjustments in laser power within each layer, with the relationship between laser power and meltpool temperature derived from simulations using the thermal code GAMMA [10]. A schematic overview of the workflow is shown in FIG. 1.

As disclosed herein, the system and method calculates the power corrections offline for a complex demonstration part in an application of the predictive control. The part is placed on a build with a realistic number of neighbouring components and the build was manufactured four times: one baseline build with only nominal laser power, then three controlled builds at 0.5×, 1×, and 2× of the laser power corrections suggested by the control method. Each controlled build also included 3 additional uncontrolled baseline samples. All the samples were then analysed using X-Ray Computed Tomography (XCT).

### Build Apparatus

The four build plates were fabricated on a DMG MORI LASERTEC 12 SLM (DMG MORI, Davis, CA) using AlSi 10 Mg powder (TEKNA, Quebec, Canada). This system employs a 1070 nm, 400 W IPG fiber laser and an in-situ meltpool monitoring (MPM) system developed by Sigma Additive Manufacturing, Santa Fe, NM. Spectral emissions from the meltpool were captured using coaxial photodiodes operating at 200 kHz, which process emissions in two narrow bandwidths and calibrate them to temperature [12], akin to a two-color pyrometry method. This value is referred to as the Thermal Emission Planck (TEP). In some examples, spectral emissions from the meltpool may be captured using coaxial photodiodes operating at for example, at least, greater than, less than, equal to, or any number in between about, 1 kHz, 2 kHz, 3 kHz, 4 kHz, 5 kHz, 6 kHz, 7 kHz, 8 kHz, 9 kHz, 10 kHz, 11 kHz, 12 kHz, 13 kHz, 14 kHz, 15 kHz, 16 kHz, 17 kHz, 18 kHz, 19 kHz, 20 kHz, 21 kHz, 22 kHz, 23 kHz, 24 kHz, 25 kHz, 26 kHz, 27 kHz, 28 kHz, 29 kHz, 30 kHz, 31 kHz, 32 kHz, 33 kHz, 34 kHz, 35 kHz, 36 kHz, 37 kHz, 38 kHz, 39 kHz, 40 kHz, 41 kHz, 42 kHz, 43 kHz, 44 kHz, 45 kHz, 46 kHz, 47 kHz, 48 kHz, 49 kHz, 50 kHz, 51 kHz, 52 kHz, 53 kHz, 54 kHz, 55 kHz, 56 kHz, 57 kHz, 58 kHz, 59 kHz, 60 kHz, 61 kHz, 62 kHz, 63 kHz, 64 kHz, 65 kHz, 66 kHz, 67 kHz, 68 kHz, 69 kHz, 70 kHz, 71 kHz, 72 kHz, 73 kHz, 74 kHz, 75 kHz, 76 kHz, 77 kHz, 78 kHz, 79 kHz, 80 kHz, 81 kHz, 82 kHz, 83 kHz, 84 kHz, 85 kHz, 86 kHz, 87 kHz, 88 kHz, 89 kHz, 90 kHz, 91 kHz, 92 kHz, 93 kHz, 94 kHz, 95 kHz, 96 kHz, 97 kHz, 98 kHz, 99 kHz, 100 kHz, 101 kHz, 102 kHz, 103 kHz, 104 kHz, 105 kHz, 106 kHz, 107 kHz, 108 kHz, 109 kHz, 110 kHz, 111 kHz, 112 kHz, 113 kHz, 114 kHz, 115 kHz, 116 kHz, 117 kHz, 118 kHz, 119 kHz, 120 kHz, 121 kHz, 122 kHz, 123 kHz, 124 kHz, 125 kHz, 126 kHz, 127 kHz, 128 kHz, 129 kHz, 130 kHz, 131 kHz, 132 kHz, 133 kHz, 134 kHz, 135 kHz, 136 kHz, 137 kHz, 138 kHz, 139 kHz, 140 kHz, 141 kHz, 142 kHz, 143 kHz, 144 kHz, 145 kHz, 146 kHz, 147 kHz, 148 kHz, 149 kHz, 150 kHz, 151 kHz, 152 kHz, 153 kHz, 154 kHz, 155 kHz, 156 kHz, 157 kHz, 158 kHz, 159 kHz, 160 kHz, 161 kHz, 162 kHz, 163 kHz, 164 kHz, 165 kHz, 166 kHz, 167 kHz, 168 kHz, 169 kHz, 170 kHz, 171 kHz, 172 kHz, 173 kHz, 174 kHz, 175 kHz, 176 kHz, 177 kHz, 178 kHz, 179 kHz, 180 kHz, 181 kHz, 182 kHz, 183 kHz, 184 kHz, 185 kHz, 186 kHz, 187 kHz, 188 kHz, 189 kHz, 190 kHz, 191 kHz, 192 kHz, 193 kHz, 194 kHz, 195 kHz, 196 kHz, 197 kHz, 198 kHz, 199 kHz, 200 kHz, 201 kHz, 202 kHz, 203 kHz, 204 kHz, 205 kHz, 206 kHz, 207 kHz, 208 kHz, 209 kHz, 210 kHz, 211 kHz, 212 kHz, 213 kHz, 214 kHz, 215 kHz, 216 kHz, 217 kHz, 218 kHz, 219 kHz, 220 kHz, 221 kHz, 222 kHz, 223 kHz, 224 kHz, 225 kHz, 226 kHz, 227 kHz, 228 kHz, 229 kHz, 230 kHz, 231 kHz, 232 kHz, 233 kHz, 234 kHz, 235 kHz, 236 kHz, 237 kHz, 238 kHz, 239 kHz, 240 kHz, 241 kHz, 242 kHz, 243 kHz, 244 kHz, 245 kHz, 246 kHz, 247 kHz, 248 kHz, 249 kHz, 250 kHz, 251 kHz, 252 kHz, 253 kHz, 254 kHz, 255 kHz, 256 kHz, 257 kHz, 258 kHz, 259 kHz, 260 kHz, 261 kHz, 262 kHz, 263 kHz, 264 kHz, 265 kHz, 266 kHz, 267 kHz, 268 kHz, 269 kHz, 270 kHz, 271 kHz, 272 kHz, 273 kHz, 274 kHz, 275 kHz, 276 kHz, 277 kHz, 278 kHz, 279 kHz, 280 kHz, 281 kHz, 282 kHz, 283 kHz, 284 kHz, 285 kHz, 286 kHz, 287 kHz, 288 kHz, 289 kHz, 290 kHz, 291 kHz, 292 kHz, 293 kHz, 294 kHz, 295 kHz, 296 kHz, 297 kHz, 298 kHz, 299 kHz, 300 kHz, 301 kHz, 302 kHz, 303 kHz, 304 kHz, 305 kHz, 306 kHz, 307 kHz, 308 kHz, 309 kHz, 310 kHz, 311 kHz, 312 kHz, 313 kHz, 314 kHz, 315 kHz, 316 kHz, 317 kHz, 318 kHz, 319 kHz, 320 kHz, 321 kHz, 322 kHz, 323 kHz, 324 kHz, 325 kHz, 326 kHz, 327 kHz, 328 kHz, 329 kHz, 330 kHz, 331 kHz, 332 kHz, 333 kHz, 334 kHz, 335 kHz, 336 kHz, 337 kHz, 338 kHz, 339 kHz, 340 kHz, 341 kHz, 342 kHz, 343 kHz, 344 kHz, 345 kHz, 346 kHz, 347 kHz, 348 kHz, 349 kHz, 350 kHz, 351 kHz, 352 kHz, 353 kHz, 354 kHz, 355 kHz, 356 kHz, 357 kHz, 358 kHz, 359 kHz, 360 kHz, 361 kHz, 362 kHz, 363 kHz, 364 kHz, 365 kHz, 366 kHz, 367 kHz, 368 kHz, 369 kHz, 370 kHz, 371 kHz, 372 kHz, 373 kHz, 374 kHz, 375 kHz, 376 kHz, 377 kHz, 378 kHz, 379 kHz, 380 kHz, 381 kHz, 382 kHz, 383 kHz, 384 kHz, 385 kHz, 386 kHz, 387 kHz, 388 kHz, 389 kHz, 390 kHz, 391 kHz, 392 kHz, 393 kHz, 394 kHz, 395 kHz, 396 kHz, 397 kHz, 398 kHz, 399 kHz, 400 kHz, 401 kHz, 402 kHz, 403 kHz, 404 kHz, 405 kHz, 406 kHz, 407 kHz, 408 kHz, 409 kHz, 410 kHz, 411 kHz, 412 kHz, 413 kHz, 414 kHz, 415 kHz, 416 kHz, 417 kHz, 418 kHz, 419 kHz, 420 kHz, 421 kHz, 422 kHz, 423 kHz, 424 kHz, 425 kHz, 426 kHz, 427 kHz, 428 kHz, 429 kHz, 430 kHz, 431 kHz, 432 kHz, 433 kHz, 434 kHz, 435 kHz, 436 kHz, 437 kHz, 438 kHz, 439 kHz, 440 kHz, 441 kHz, 442 kHz, 443 kHz, 444 kHz, 445 kHz, 446 kHz, 447 kHz, 448 kHz, 449 kHz, 450 kHz, 451 kHz, 452 kHz, 453 kHz, 454 kHz, 455 kHz, 456 kHz, 457 kHz, 458 kHz, 459 kHz, 460 kHz, 461 kHz, 462 kHz, 463 kHz, 464 kHz, 465 kHz, 466 kHz, 467 kHz, 468 kHz, 469 kHz, 470 kHz, 471 kHz, 472 kHz, 473 kHz, 474 kHz, 475 kHz, 476 kHz, 477 kHz, 478 kHz, 479 kHz, 480 kHz, 481 kHz, 482 kHz, 483 kHz, 484 kHz, 485 kHz, 486 kHz, 487 kHz, 488 kHz, 489 kHz, 490 kHz, 491 kHz, 492 kHz, 493 kHz, 494 kHz, 495 kHz, 496 kHz, 497 kHz, 498 kHz, 499 kHz, and 500 kHz.

### Data Generation and Control

The demonstration part, shown in FIG. 1, features a complex geometry including overhangs, through-holes, thin walls, and bulk sections. The part was built using 360 W laser power, a 1550 mm/s hatch speed, 150 μm hatch spacing, and 30 μm layer thickness, resulting in a total height of 7 mm across 234 layers. The toolpath for the build was generated in DMG MORI's CELOS software and spatially calibrated.

The demonstration part is shown in FIG. 1 as the Part CAD, with its location on the build plate circled in red on the Controlled Build. The demonstration part is approximately 10 mm wide, and includes complex features such as overhangs, three (3) through-holes, four (4) thin wall sections in varied thicknesses, and larger bulk sections. The part is nominally produced with 360 W laser power, 1550 mm/s hatch speed, 150 μm hatch spacing, and 30 μm layers. The total height is approximately 7 mm or 234 layers.

The toolpath for the part was generated by and exported from the build control software-DMG MORI CELOS. In this work, the toolpath was exported after the application of the SLM machine spatial calibration. With the exported toolpath, previously developed mechanistic features (MF) are calculated. The MF describe local geometry of the printed part (solid distribution features sd, edge distribution features ed) and the local toolpath pattern (lt). The calculated MF along with the laser scanning speed are fed into a ML model developed and trained in our prior work [9]. The ML model was trained on data collected from identical parts previously built on the same system using the nominal build parameters (constant laser power of 360 W). One key advantage of these MF is the ability to effectively capture the accumulated thermal effects from the toolpath pattern, geometry from the neighboring parts, and the previous layers, which is a dominant factor impacting SLM part quality. The ML model predicts the meltpool TEP signals based on the MF.

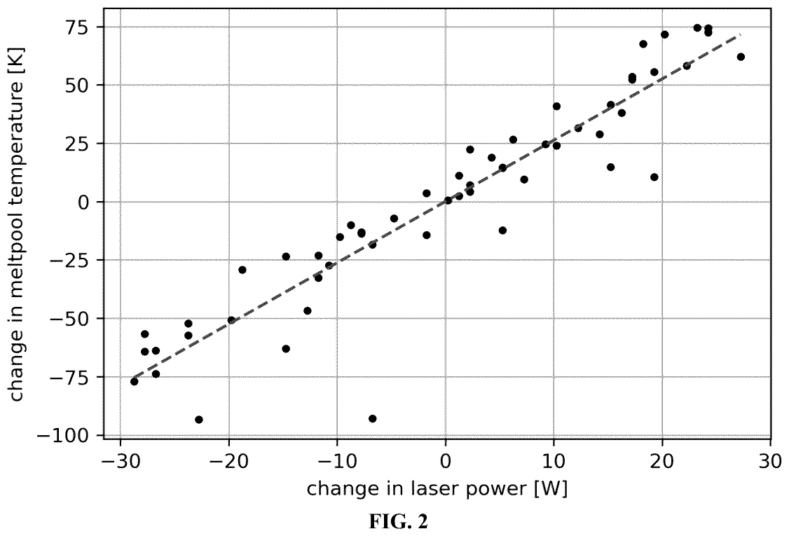

The ML predictions are used to generate intra-layer laser corrections driven by a GAMMA simulation derived relationship. To determine the relationship between laser power changes and meltpool temperature changes, a simulation of three layers with similar process parameters as the real builds was performed. These layers had a similar scan area to the test part, including thin strips representing thin wall sections, and a large square area representing bulk sections. Only the third layer was used to determine the relationship between changes in laser power and meltpool temperature. The laser power was changed within the scanning of the third layer for randomly selected durations of 1 to 5 ms. The laser power values were randomly selected from 300 to 360 W to capture the effects of laser power reductions from the nominal laser power. The meltpool temperature was extracted as the simulation domain temperature at the laser location for each timestep. The change in laser power and the change in meltpool temperature were calculated for each timestep. This data is shown in FIG. 2. A linear relationship (R2=0.87) was found between the changes in laser power and the subsequent changes in the simulated meltpool temperature. The resulting conversion factor is 2.5° C./W: a 1 W change in the laser power results in a 2.5° C. change in the meltpool temperature. It is worth noting that while the extracted meltpool temperature and TEP metrics are not directly comparable, the relative changes of each that are used for the present control method are comparable.

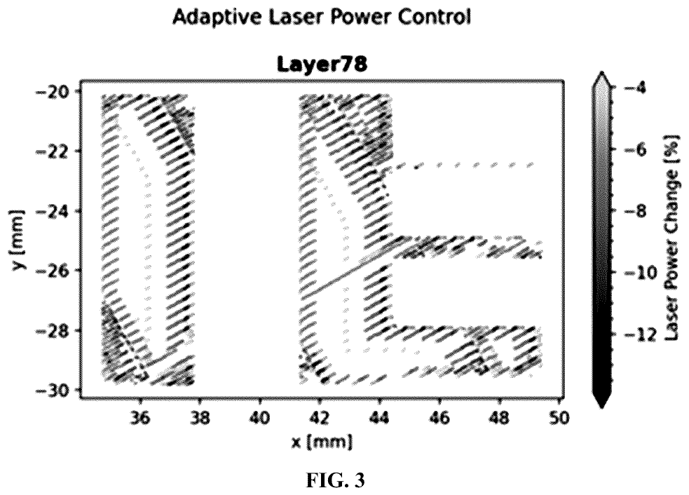

Finally, the correlation obtained from FIG. 2 allows the implementation of the laser power correction strategy along the scanning path. The build region is discretized into square cells of 50 um×50 um. These cells are mapped to the laser toolpath, and the change in laser power is applied to toolpath points within each cell. In this work, only laser power reductions were implemented as our additional research on TEP data has found a surprising lower value while the temperature value should be higher at the overhang region [9]. Therefore, to avoid an incorrect laser power increase in overhang regions, only power reduction in this implementation is enabled. A sample of the generated corrections of laser power is shown in FIG. 3 for a sample layer.

Power changes were generated at 3 different magnitudes: 0.5×, 1×, and 2× of the nominal power changes prescribed by GAMMA. These corrections were applied to one part in each build. Three identical parts were built without control in these builds. A fourth baseline build contained only uncontrolled parts. After the 4 builds were completed, the samples were removed by wire EDM. No post process heat treatments were conducted so that the results are the direct reflection of only the processing conditions.

### Sample XCT Characterization

X-ray CT (XCT) scan measurements of SLM parts provide part quality data that can match the dimensionality of 3D process and monitoring data, while preserving the integrity of the sample. This analysis method allows the simultaneous measurement of multiple quality metrics, including geometric accuracy, part density, and defect morphology. This method used a Zeiss Metrotom 800 HR 225 kV CT system, with minimum focal spot of 7 μm and a cone beam X-ray source. The scan settings were 160 kV voltage, 121 μA current, 2 mm aluminum filter, 1 s exposure time with 3 frames averaging, 580 projections/rotation, resulting in 17.3 μm/voxel resolution.

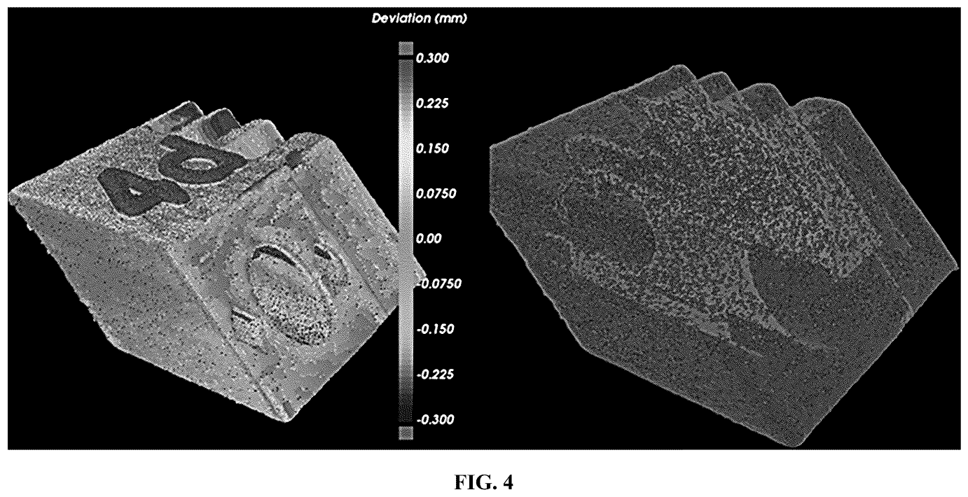

As disclosed herein, images were reconstructed using the Model Based Image Recognition (MBIR) reconstruction method described in [12]. MBIR is an automated deep-learning-based processing routine that analyzes the reconstructed images to identify defect locations, sizes, and aspect ratios. The image alignment to the nominal CAD model was performed using Random Sample Consensus for coarse alignment and the Iterative Closest Point algorithm for fine alignment. This alignment allowed for the rapid extraction of localized densities and defect statistics in certain regions of interest, overcoming one major bottleneck for general CT methods, i.e., time needed for analysis. FIG. 4 shows the analyzed and aligned data of the baseline sample.

### Results and Discussion

### Effect of Adaptive Power Control on Bulk Material Density

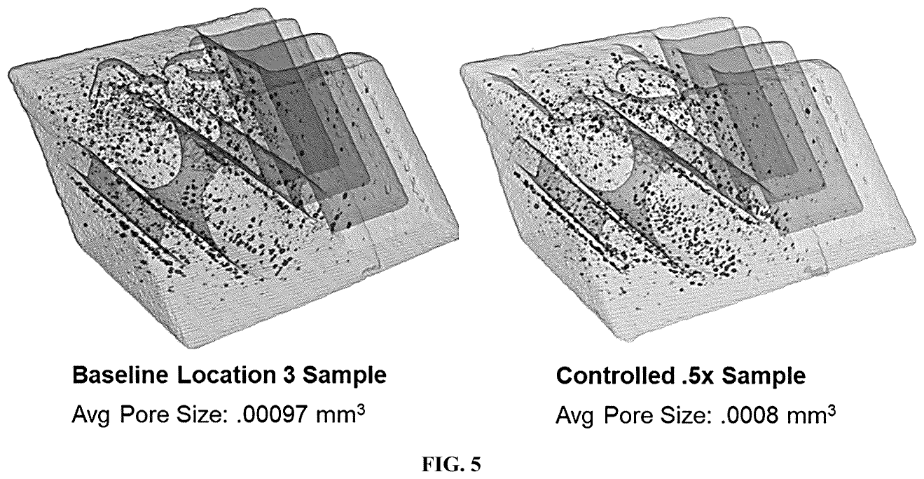

In total, 18 geometry coupons were produced across the 4 builds and analyzed. Of these samples 3 used adaptive power settings and 15 used static power. The 15 static power coupons were arranged in different locations on the build plate to ensure a reduction of bias for the comparison. A comparison of the interior defects of a baseline part and 0.5× controlled part are shown in FIG. 5. The most noteworthy difference is the quantitative differences in average pore size and pore size standard deviation. The direct comparison shown in FIG. 5 demonstrates an 18% reduction in average pore size. One can also qualitatively see this difference around the base and side of the through-hole geometry features as well as the transition from bulk to thin feature geometry. The results clearly indicate that the correction strategy at the base of the through-hole geometry and no-overhang regions had a pore size reducing effect.

To gain a deeper understanding of how the adaptive strategies 0.5×, 1×, 2× compared to the baseline samples at 3 locations the average pore size and standard deviation of the average pore size was calculated for each group of samples as shown in Table 1.

TABLE 1
Comparison of Pore Size Statistics

| | Std (mm³) | Difference | Average (mm³) | Difference |
|---|---|---|---|---|
| Controlled | 0.000055 | — | 0.00879 | — |
| (0.5x, 1x, 2x) | | | | |
| Baseline Loc. 1 | 0.000064 | 14% | 0.000934 | 6% |
| Baseline Loc. 2 | 0.00017 | 69% | 0.001040 | 16% |
| Baseline Loc. 3 | 0.000186 | 70% | 0.00963 | 9% |

### Meltpool Monitoring Analysis

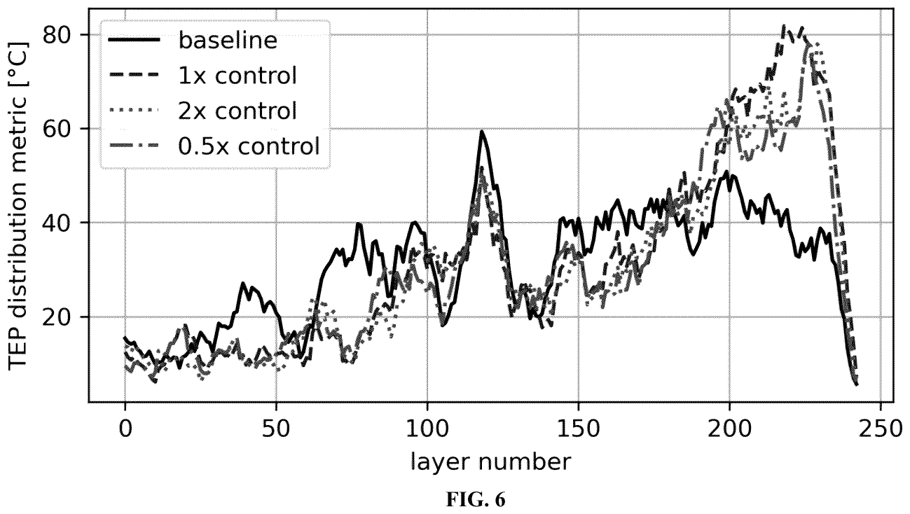

Since the objective of the proposed adaptive control method is to reduce the intralayer variation in melt pool temperature, analysis of the MPM data was conducted to determine if the TEP values were more constant in the controlled builds. A TEP distribution metric (TEP-DM) was calculated for each layer by calculating the absolute value of the difference in mean TEP values located inside vs outside the correction cells described above. The TEP-DM is shown in FIG. 6 for the whole build with a smoothing filter of 10 layers applied to reduce noise.

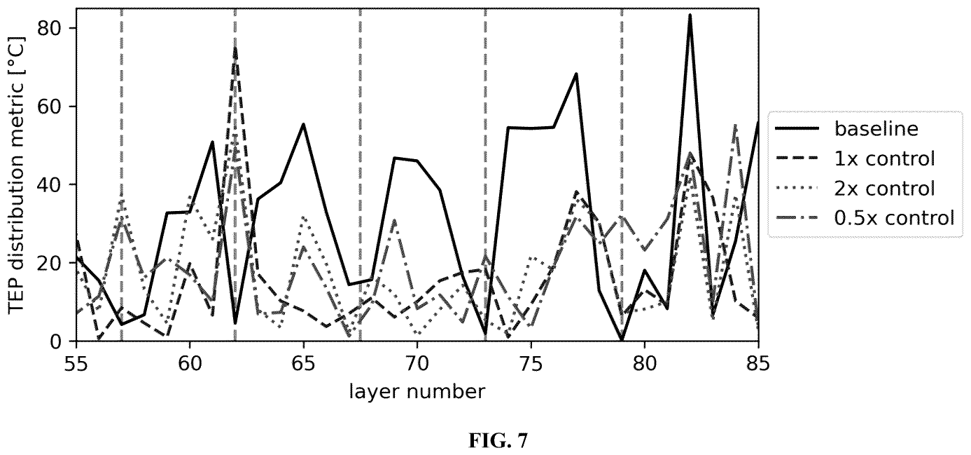

Based on the TEP-DM, the efficacy of the presented control method varies through the build height. An improved, lower TEP-DM is shown in layers 30-50 and layers 60-80. It should be noted that layers 60-80 correspond to the start of the through-hole geometry where qualitative and quantitative differences were shown in FIG. 7. Layers 60-80 show a statistically significant lower average TEP-DM in the controlled builds than in the baseline. The averages and associated p-values shown in Table 2 indicate that in these layers, the controlled builds have a more consistent TEP value than that in the baseline build. It appears that the reduction in the TEP-DM is due to the reduction of a cyclical fluctuation every 5-6 layers in the baseline TEP-DM marked with vertical grey lines.

TABLE 2
TEP-DM averages and p-values (compared
to baseline) for layer 60-80.

| | | 1x | 0.5x | 2x |
|---|---|---|---|---|
| | Baseline | control | control | control |
| Average | 33.87 | 16.50 | 16.91 | 17.77 |
| TEP-DM [° C.] | | | | |
| p-value | — | 0.0055 | 0.0031 | 0.0068 |

The difference in improvement of the TEP-DM for layers 185+ may be due to the completion of the through-holes. The resulting overhang and drastic changes in cross-section may increase the accumulated heat and temperature of the entire layer, inducing a deeper keyhole in controlled areas, which may impact the reliability of TEP measurements [9]. This may be exacerbated by the fact that the calibration curve, see FIG. 2, was obtained from a single layer low in the build and the relationship between laser power and temperature changes may shift higher in the build. It is also noteworthy that the main source of improvement in layer 60-80 stems from the 5-6-layer periodic fluctuations. The hatch pattern is rotated by 63.5 degrees so this period aligns with a full rotation of the hatch, suggesting that the control methodology is correcting a phenomenon caused by the scanning direction.

As disclosed herein, the systems and methods may include a predictive control approach for SLM, designed to maintain a stable meltpool temperature in Laser Powder Bed Fusion. The disclosed approach used mechanistic features derived from the toolpath to predict regions for which lower laser power was required. After completing baseline and controlled builds, and analyzing both meltpool monitoring and X-ray CT data, it was concluded that the methods provide: 1) reduced on average the pore size by 12% and the standard deviation by 65%; 2) qualitatively appeared to reduce the pore size in regions below, and on the sides of, the through-hole geometry where adaptive control was applied; 3) reduced the MPM signal variation for certain regions, specifically those with layer ranges 30-50 and 60-80; and 4) reduced the meltpool fluctuation due to scan direction dependence.

The systems and methods disclosed herein may be improved by training the ML model on data produced with dynamic laser power, such as the data generated for this disclosure; building a more robust meltpool measurement and laser power relationship considering the changing of boundary conditions through the build height; and training on objectives such as porosity reduction vs. just homogenization of TEP signal.

The systems and methods disclosed herein may also be adapted for use in other additive manufacturing processes to include electron-beam powder bed fusion (EPBF) and directed energy deposition (DED).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

### REFERENCES

[1] Cai, Y., Xiong, J., Chen, H., Zhang, G., 2023, A review of in-situ monitoring and process control system in metal-based laser additive manufacturing, J. of Manufacturing Systems 70:309-326.
[2] Rezaeifar, H., Elbestawi, M. A., 2021, On-line meltpool temperature control in L-PBF additive manufacturing. Int'l J. of Advanced Manufacturing Technology 112:2789-2804.
[3] Riensche, A., Bevans, B. D., Smoqi, Z., Yavari, R., Krishnan, A., Gilligan, J., Piercy, N., Cole, K., Rao, P., 2022, Feedforward control of thermal history in laser powder bed fusion: Toward physics-based optimization of processing parameters. Materials and Design, 224.
[4] Kavas. B., Balta, E. C., Tucker, M., Rupenyan, A., Lygeros, J., Bambach, M., 2023, Layer-to-layer closed-loop feedback control application for inter-layer temperature stabilization in laser powder bed fusion, Additive Manufacturing 78.
[5] Renken, V., Lubbert, L., Blom, H., Von Freyberg, A., Fischer, A., 2018, Model assisted closed-loop control strategy for selective laser melting, Procedia CIRP, 74:659-663.
[6] Wang, R., Standfield, S., Dou, C., Law, A. C., Kong, Z. J., 2023, Real-time process monitoring and closed-loop control on laser power via a customized laser powder bed fusion platform, Additive Manufacturing 66.
[7] Srinivasan, S., Wick, B., Groeber, M. A., 2024, Optimization of Local Processing Conditions in Complex Part Geometries Through Novel Scan Strategy in Laser Powder Bed Fusion Process, Application of Machine Learning in Material development and Manufacturing 76/1.
[8] Liao, S., Jeong, J., Zha, R., Xue, T., Cao, J., 2023, Simulation-guided feedforward-feedback control of meltpool temperature in directed energy deposition, CIRP annals-Manufacturing Technology 72:157-160.
[9] Kozjek, D., Porter, C., Carter, F. M., Mogonye, J.-E., Cao, J., 2023 Data-driven prediction of geometry- and toolpath sequence-dependent intra-layer process conditions variations in laser powder bed fusion. J. of manufacturing proc. 100/3.
[10] Mozaffar, M., Ndip-Agbor, E., Lin, S., Wagner, G., Ehmann, K., Cao, J., 2019, Acceleration strategies for explicit finite element analysis of metal powder based additive manufacturing processes using graphical processing units, Computational Mechanics, 64:879-894.
[11] Lane, B., Jacquemetton, L., Piltch, M., Beckett, D., 2020, Thermal calibration of commercial meltpool monitoring sensors on a laser powder bed fusion system, NIST Advanced Manufacturing Series 100-35.
[12] Ziabari, A., Venkatakrishnan, S. V., Snow, Z., Lisovich, A., Sprayberry, M., Brackman, P., Frederick, C., Bhattad, P., Graham, S., Bingham, P., Dehoff, R., Plotkowski, A., Paquit, V., 2023, Enabling rapid X-ray CT characterization for additive manufacturing using CAD models and deep learning-based reconstruction. Npj Computational Materials 9.

What is claimed is:

1. A method for adaptive control of laser power during selective laser melting of comprising:
generating a toolpath for at least one part;
calculating at least one mechanistic feature of the at least one part;
inputting a laser power and scanning speed and the calculated mechanistic feature of the at least one part into a machine learning model;
predicting meltpool temperature variations along the toolpath path based on the machine learning model;
determining laser power adjustments based on predicted meltpool temperature variations; and
dynamically adjusting the laser power during a build process at specific points along the toolpath based on the predicted meltpool temperature variations to maintain a desired meltpool temperature profile; and
generating the at least one part.

2. The method of claim 1, wherein the at least one part comprises a metal, a polymer, a ceramic, or combinations thereof.

3. The method of claim 1, wherein a portion of the at least one part comprises a metal, a polymer, a ceramic, or combinations thereof.

4. The method of claim 1, wherein the at least one mechanistic feature is calculated using a geometry of the part and the generated toolpath.

5. The method of claim 1, wherein a co-axial photodiode is used to collect meltpool spectral emissions during the build process.

6. The method of claim 1, wherein a thermal simulation model is used to determine laser power adjustments using a relationship between changes in laser power and meltpool temperature.

7. The method of claim 1, wherein meltpool temperature data is collected at least at 100 kHz.

8. A system configured to generate a part in accordance with the method of claim 1.

9. The system of claim 8, wherein the system comprises a 1070 nm wavelength, 400 W fiber laser.

10. An adaptive laser power control system for selective laser melting configured to generate a part comprising:
a machine learning model configured to predict optimal laser power settings based on a geometry of the part and a generated toolpath;
a co-axial photodiode system for monitoring meltpool spectral emissions;
a control algorithm that adjusts laser power dynamically along the toolpath, based on predicted meltpool temperatures from the machine learning model; and
a laser.

11. The system of claim 10, wherein the part comprises a metal, a polymer, a ceramic, or combinations thereof.

12. The system of claim 10, wherein a portion of the part comprises a metal, a polymer, a ceramic, or combinations thereof.

13. The system of claim 10, wherein the control algorithm uses a relationship between laser power and predicted meltpool temperatures derived from a thermal simulation to dynamically adjust the laser power during a build process.

14. The system of claim 10, wherein the co-axial photodiode system utilizes a two-color pyrometry to calculate real-time meltpool temperatures.

15. A method for manufacturing a part using selective laser melting, comprising:
using a co-axial photodiode system to monitor real-time meltpool temperatures during a build process;
implementing a machine learning model to predict laser power adjustments based on a geometry of the part and a generated toolpath;
dynamically adjusting laser power during the build to optimize meltpool temperature; and
generating the part.

16. The method of claim 15, wherein the part comprises a metal, a polymer, a ceramic, or combinations thereof.

17. The method of claim 15, wherein a portion of the part comprises a metal, a polymer, a ceramic, or combinations thereof.

18. The method of claim 15, wherein a control algorithm adjusts laser power dynamically along the generated toolpath based on predicted meltpool temperatures from the machine learning model and real-time meltpool temperatures during the build process.

19. A non-transitory machine-readable medium storing instructions that, when executed by one or more processors, cause the one or more processors to perform steps comprising:
generating a toolpath for a part for a selective laser melting build process;
calculating at least one mechanistic feature of the part;
inputting a laser scanning speed and the calculated at least one mechanistic feature of the part into a machine learning model;
predicting meltpool temperature variations along the toolpath path based on the machine learning model;
determining laser power adjustments based on predicted meltpool temperature variations; and
dynamically adjusting the laser power during the build process at specific points along the toolpath based on the predicted meltpool temperature variations to maintain a desired meltpool temperature profile; and
generating the part.

20. The non-transitory machine-readable medium storing instructions of claim 20, wherein the part comprises a metal, a polymer, a ceramic, or combinations thereof.
